(19) United States
(12) Patent Application Publication
(10) Pub. No.: US 2013/0084053 A1
(43) Pub. Date: Apr. 4, 2013

(54) System to merge multiple recorded video timelines

(71) Applicants: Mitch Ackermann, Cedar Park, TX (US); Jeffry Ratcliff, Austin, TX (US); Jeremy Schwartz, Austin, TX (US)

(72) Inventors: Mitch Ackermann, Cedar Park, TX (US); Jeffry Ratcliff, Austin, TX (US); Jeremy Schwartz, Austin, TX (US)

(73) Assignee: UTC Fire & Security Corporation, Farmington, CT (US)

(21) Appl. No.: 13/200,898

(22) Filed: Oct. 4, 2011

(51) Int. Cl. H04N 9/80

(52) U.S. Cl. 386/241; 386/E05.003

(57) ABSTRACT

A video recording and playback network comprises a video source, a plurality of recorders, a local server, and a client device. The plurality of recorders records video from the video source. The local server generates a playlist comprising one or more ordered video segments which together cover a desired time range. The playlist associates one of the plurality of recorders with each video segment. The client device plays back video according to the playlist by streaming each video segment, in sequence, from the associated recorder.

### BACKGROUND

The present invention relates generally to video playback, and more particularly to a system and method for merging timelines from diverse sources of recorded video.

Video capture commonly requires both a video source, such as a digital video camera, and at least one recorder which samples real time video from the source, encodes this video using one or more video codecs at a specified frame rate and resolution, and stores resulting video footage. It is standard practice in the field of video surveillance and security to record video from one camera with multiple recorders. Security cameras in banks, for instance, commonly feed both short-term and long-term recorders. A short-term encoder may encode high frame rate video, but only store video for a few days before deletion. A long-term recorder, by contrast, may encode video at a low frame rate, but store video indefinitely. Some security systems also utilize multiple backup recorders for redundancy in case of hardware failure or sabotage. Some such recorders may be located on the same premises as the source video camera, while others may be located at remote facilities. Many security systems utilize recorders from a plurality of vendors. Each recorder may utilize proprietary formats, codecs, or protocols which are not compatible with recorders from other vendors.

High resolution and frame rate are desirable when viewing captured video. Where video from a single source is encoded by multiple recorders, the highest quality video footage over a time period of interest may be spread across multiple recorders. A short-term recorder, for instance might have high frame rate video footage available for recent portions of the period of interest, but have no footage available for older portions of the period of interest. A long-term recorder, by contrast, might have footage available for the entirety of the period of interest, but only at a lower frame rate. Similarly, hardware failure may produce gaps in high quality video footage from a first recorder, which could be filled in with lower quality footage from a second recorder. The highest quality available video footage over a time period of interest may thus be found on multiple recorders, and may be stored in multiple incompatible vendor-specific formats.

### SUMMARY

The present invention is directed toward a system and method for merging multiple recorded video timelines with a video recording and playback network comprising a video source, a plurality of recorders, a local server, and a client device. The plurality of recorders records video from the video source. The local server generates a playlist comprising one or more ordered video segments which together cover a desired time range. The playlist associates one of the plurality of recorders with each video segment. The client device plays back video according to the playlist by streaming each video segment, in sequence, from the associated recorder.

### BRIEF DESCRIPTION OF THE DRAWINGS

FIG. 1 is a block diagram of a video recording and playback network

FIG. 2 is a block diagram of a playlist produced by the video recording and playback system of FIG. 1.

FIG. 3 is a block diagram of a client device in the video recording and playback network of FIG. 1.

FIG. 4 is a flowchart of a method of use of the video recording and playback network of FIGS. 1 and 2.

### DETAILED DESCRIPTION

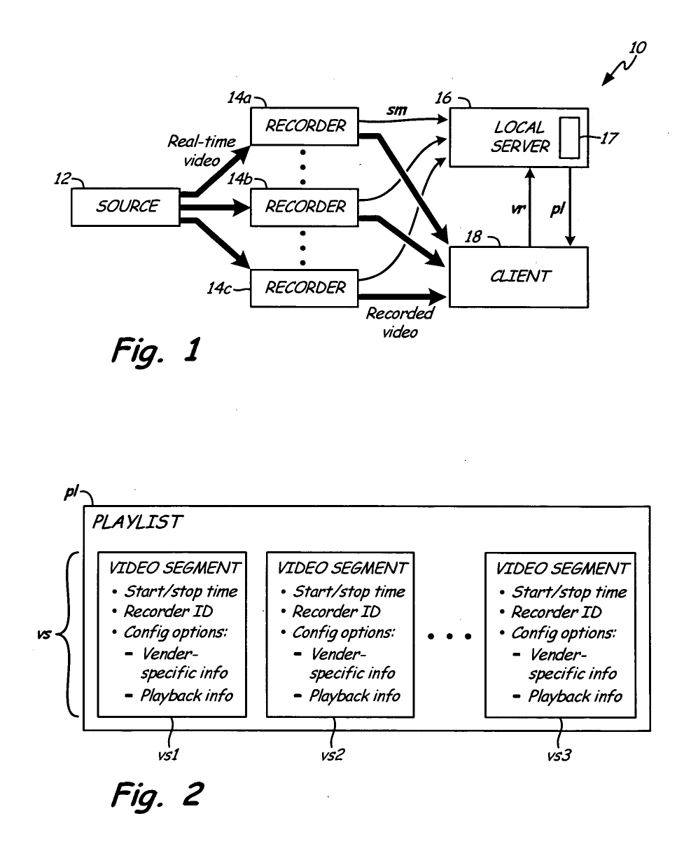

FIG. 1 is a block diagram of video recording and playback network 10, comprising source 12, recorders 14a, 14b, and 14c, local server 16, and client device 18. Source 12 is a video source such as a digital camera. Recorders 14a, 14b, and 14c represent a plurality of recorders which record and store archive real-time video from source 12. Although three recorders are shown, any number of recorders may be used. Different recorders 14a, 14b, and 14c may record video at different resolutions and frame rates, and may retain stored video for different lengths of time before deletion. Recorders 14a, 14b, and 14c may be recorders of different brands, running mutually incompatible vendor-specific software and encoding video using multiple, mutually incompatible codecs. By way of example, recorder 14a may be a long-term storage recorder which stores low frame rate video for several months in vendor A's format, while recorder 14b may be a short-term storage recorder which stores high frame rate video for a handful of days in vendor B's format. Local server 16 is a processing server in data communication with client device 18 and the plurality of recorders 14a, 14b, and 14c. Local server 16 possesses library 17, a list or database of recorders including recorders 14a, 14b, and 14c, and potentially including other recorders (not shown) which receive video from other sources than source 12. Library 17 identifies the source recorded by each listed recorder, as well as vendor-specific information particular to each recorder, such as protocols or codecs used by that recorder. Library 17 may also indicate the location of each listed recorder.

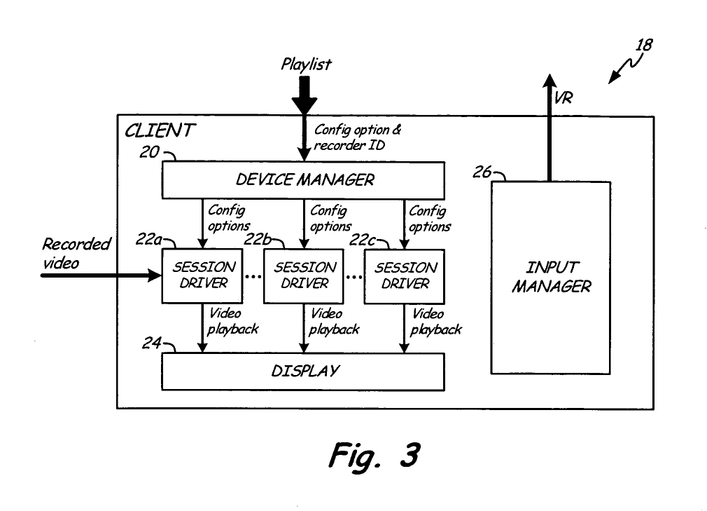

Client device 18 is a user-side device with input means allowing a user to request particular video, and output means for displaying requested video. Client device 18 is depicted and described in greater detail with respect to FIG. 3, below. Client device 18 accepts video requests vr from users, and transmits these video requests to local server 16. Although only one client device 18 is shown in FIG. 1, local server 16 may serve multiple clients in parallel. Each video request yr identifies a particular range of video by source (e.g. source 12, or external camera 5) and time (e.g. between 6 pm November 1st and 6 am Nov. 2, 2012). Local server 16 references library 17 to assemble a list of recorders which receive video from the specified source (e.g. recorders 14a, 14b, and 14c for source 12), and queries each such recorder about the requested video time. In the depicted embodiment, local server 16 queries recorders 14a, 14b, and 14c, which respond to this query with video status message sm indicating whether any portion of the specified video is available, and the frame rate and resolution of available portions of the specified video range. In some embodiments of video recording and playback network 10, video status message sm also indicates the present load on the responding recorder 14a, 14b, or 14c, such as from network traffic or CPU usage.

Local server 16 processes video status messages sm to produce playlist pl, a list of ordered video segments vs, which together make up the entire video range requested in video request vr, or for as close to the entire requested video range as possible. Each video segment vs is selected to provide the highest quality video available, based on status messages sm. Playlist pl is transmitted to and processed by client device 18, as described below with respect to FIGS. 2 and 3.

FIG. 2 is a block diagram of playlist pl, comprising the plurality of video segments vs described above with respect to FIG. 1, including video segments vs1, vs2, and vsN. Although three video segments vs are shown in FIG. 2, playlist pl may comprise any number of video segments which together constitute the video range requested in video request yr. Local server 16 assembles playlist pl by evaluating the quality of video available from each recorder, according to video status messages sm and reference information from library 17. In particular, local server 16 selects the video with the highest resolution and frame rate available on queried recorders. Secondarily, local server 16 may prefer long, continuous video segments available from a few recorders to a large number of shorter segments from many separate recorders. Local server 16 may also prefer recorders at closer locations, or with lower recorder loads, so as to minimize the burden placed on video recording and playback network 10. Each video segment vs includes an indication of the start and stop time of that video segment, a recorder ID identifying the recorder from which video should be streamed between the start and stop times, and a set of configuration options sufficient to enable client device 18 to stream the video from the selected recorder. These configuration options include vendor-specific information required for client device 18 to communicate with the selected recorder 14a, 14b, or 14c (such as a codec or set of protocols used by the recorder), as well as playback information required to synchronize the plurality of video segments vs (such as playback frame rate or resolution). Client device 18 streams video segments on playlist pl in sequence from specified recorders 14a, 14b, or 14c, as described below with respect to FIG. 2. By playing video segments from playlist pl, video recording and playback system 10 automatically provides a user with the highest quality video available from the plurality of recorders 14a, 14b, and 14c, for a specified video range.

FIG. 3 is an expanded block diagram of client device 18. Client device 18 comprises device manager 20, session drivers 22a, 22b, and 22c, display 24, and input manager 26. Session drivers 22a, 22b, and 22c are hardware or software drivers which stream video from recorders 14a, 14b, and 14c, respectively. Session drivers 22a, 22b, and 22c are illustrative of a plurality of drivers corresponding to the plurality of recorders described above with respect to FIG. 1. Device manager 20 is a processor which selects the appropriate session driver 22a, 22b, or 22c for each section of video based on configuration options from playlist pl, and passes those configuration options to that session driver, enabling the selected session driver to request and play the appropriate video segment. Display 24 is a monitor or screen which renders video read by session drivers 22a, 22b, and 22c. Input manager 26 includes a processor and an input device such as a keyboard and/or mouse.

Input manager 26 collects video request yr from a user, and transmits video request yr to local server 16. Local server 16 responds with playlist pl as described above with respect to FIG. 1. Client device 18 then tracks the start and stop time of the first video segment vs1 (see FIG. 2), and passes the configuration information and recorder ID for video segment vs1 to device manager 20. Device manager 20 selects a session driver (i.e. session driver 22a, 22b, or 22c) based on the recorder ID for video segment vs1, and passes the configuration options and a playback start/stop time to the selected session driver (e.g. session driver 22b for recorder 14b), which retrieves and renders video on display 24.

Client device 18 tracks the approach of the stop time of vs1. Shortly before video segment vs1 ends, client device 18 identifies the next video segment vs2 on playlist pl, and sends the configuration options and recorder ID of vs2 to device manager 20. Device manager 20 forwards this configuration data to appropriate session driver 22a, 22b, or 22c prior to the end of the preceding video segment vs1, so that video can be seamlessly streamed from playlist pl. This process repeats through each video segment vs up to final video segment vsN, after which video playback terminates.

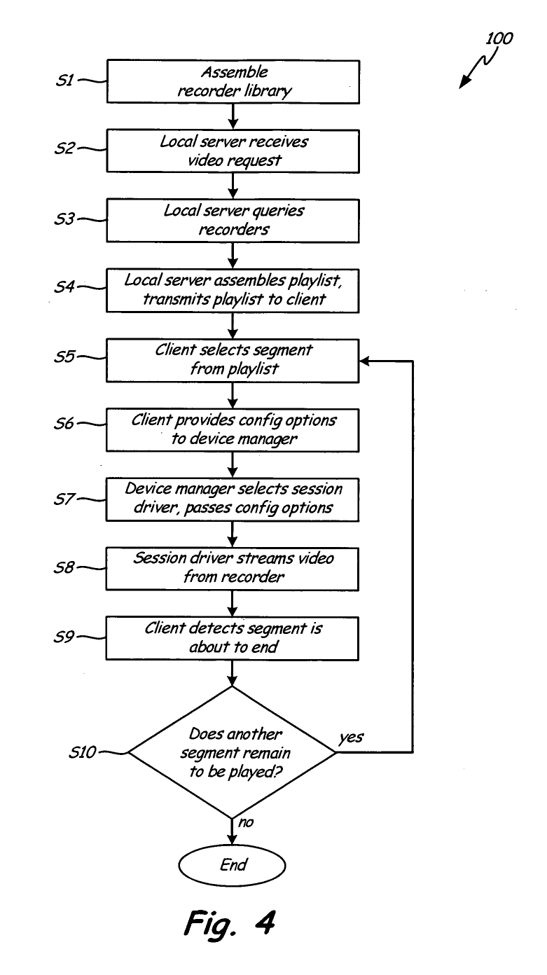

FIG. 4 is a flowchart of method 100 for playing back video with video recording and playback system 10. First, library 17 is assembled (Step S1), either manually or electronically. As discussed above, library 17 is a database or list of recorders, sources associated with each recorder, and any vendor-specific information associated with each recorder. Library 17 may be assembled (or updated) by a user as part of a configuration or setup process for video recording and playback system 10. Alternative, library 17 may be assembled automatically by local server 18 in response to periodic status checks. Once library 17 has been assembled, local server 16 can receive video request yr from input manager 26 of client device 18. (Step S2). Video request yr specifies a source and a timer period, as discussed above with respect to FIG. 1. Local server 16 then queries recorders associated with the requested source for video status messages vs, which indicate the quality of video (if any) possessed by each selected recorder. (Step S3). Local server 16 then constructs playlist pl from the highest quality video available, according to video status messages vs. (Step S4). Secondary factors such as the length of continuous video available from each recorder, the distance to each recorder, and the present load on each recorder may also be considered in assembling playlist pl, as described above. Playlist pl is then transmitted to client device 18.

Client device 18 selects first video segment vs1 from playlist pl (Step S5), and passes a recorder ID and corresponding configuration options for this video segment to device manager 20. (Step S6). Device manager 20 selects a session driver 22a, 22b, or 22c based on the recorder ID, and passes the configuration options to the selected recorder. (Step S7). The selected session driver 22a, 22b, or 22c then streams the indicated video to monitor 24, using the configuration options provided by device manager 20 to determine playback frame rate, scale resolution, and select playback start and stop times. (Step S8).

Client device 18 detects when video segment vs1 is nearing an end, (Step S9) and passes the next video segment vs2 from playlist pl to device manager 20, so that monitor 24 displays a continuous streaming video which seamlessly integrates vs1 and vs2. Client device 18 plays back video segments vs1, vs2, and vsN until no video segment remains to be played on playlist pl. (Step S10), whereupon video playback ends.

The present invention provides a system and method for automatically assembling and seamlessly joining video from an array of recorders to form a requested continuous video timeline. This system automatically selects the highest quality video available from any recorder, while simultaneously minimizing network and processor loads within video recording and playback network 10. In addition, the present invention enables recorders from a plurality of vendors to be incorporated into a single integrated video playback system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment(s) disclosed, but that the invention will include all embodiments falling within the scope of the appended claims.

1. A video recording and playback network comprising:
a video source;
a plurality of recorders which record video from the video source;
a local server which generates a playlist comprising one or more ordered video segments which together cover a desired time range, said playlist associating one of the plurality of recorders with each video segment.
a client device which plays back video according to the playlist by streaming each video segment, in sequence, from the associated recorder.

2. The video recording and playback network of claim 1, wherein the local server generates the playlist by selecting the highest quality video available from any of the plurality of recorders at each time over the desired time range.

3. The video recording and playback network of claim 2, wherein the selected video is the video with the highest resolution.

4. The video recording and playback network of claim 2, wherein the selected video is the video with the highest frame rate.

5. The video recording and playback network of claim 2, wherein the local server secondarily selects video to minimize recorder load.

6. The video recording and playback network of claim 2, wherein the local server secondarily maximizes the length of each video segment.

7. The video recording and playback network of claim 1, wherein the playlist provides start and stop times and configuration information for each video segment.

8. The video recording and playback network of claim 7, wherein the configuration information for each video segment includes codec information or vendor-specific information for the one of the plurality of recorders associated with the video segment.

9. The video recording and playback network of claim 8, wherein the plurality of recorders records video in a plurality of mutually incompatible formats.

10. A system for merging multiple recorded video timelines, the system comprising:
a plurality of recorders which record video from a common video source;
a local server which assembles a playlist of one or more ordered video segments selected to provide the highest video quality from video available from the plurality of recorders, each video segment having a start time and a stop time, and specifying one of the plurality of recorders from which to stream video between the start time and the stop time; and
a client device which streams video from the playlist, the client device comprising:
a plurality of session drivers, each capable of processing video from one or more of the recorders; and
a device manager which selects one of the plurality of session drivers for each video segment on the playlist.

11. The system of claim 10, wherein each of the session drivers is associated with at least one of the plurality of recorders.

12. The system of claim 10, wherein the local server includes a library of recorders which associates each recorder with a specific video source.

13. The system of claim 12, wherein the library also associates each recorder with a location, and wherein the local server prefers recorders at closer locations when assembling the playlist.

14. The system of claim 10, wherein the playlist includes configuration options associated with each video segment and used by the plurality of session drivers.

15. The system of claim 14, wherein the configuration options include playback frame rate and vendor-specific information specific to the specified recorder.

16. A video processing server running a software video processing method, the software video processing method comprising:
receiving a digital playlist request from a client device, the digital playlist request specifying a video source and a time range;
querying each of a plurality of video recorders for a video status indicating the availability from each recorder of video footage from the specified video source and time range; and
assembling, based on the video status, an ordered digital playlist configured for streaming and playback by the client device, the ordered digital playlist identifying one or more video segments from the specified video source via the plurality of recorders, the one or more video segments together covering the specified time range.

17. The method of claim 16, wherein the ordered digital playlist is assembled by selecting the highest quality video available from any of the plurality of digital video recorders, at each time.

18. The method of claim 16, wherein the video status is a digital message indicating whether the digital video recorder has video available for the specified time range, and if so, the frame rate and resolution of the available video.

19. The method of claim 16, wherein the playlist comprises a start and stop time and configuration settings for each video segment.

20. A video client device running a software video playback method, the software video playback method comprising:
transmitting a digital playlist request to a video server, the playlist request specifying a video source and a time range;
receiving an ordered digital playlist from the video server, the ordered digital playlist identifying one or more video segments each having a start time, a stop time, and a specified recorder, such that the video segments together provide the specified time range from the specified video source;
streaming each video segment in sequence from its specified recorder; and
rendering each video segment at a client-side monitor as it is streamed.

21. The method of claim 20, wherein streaming each video segment comprises:
selecting a session driver based on the associated recorder;
providing the session driver with the start and stop time and configuration settings for the video segment; and
retrieving and processing video from the start time to the stop time from the associated recorder, using the configuration settings.
